(19) United States
(12) Patent Application Publication
(10) Pub. No.: US 2009/0033118 A1
(43) Pub. Date: Feb. 5, 2009

(54) Accessory tray and entertainment system for stroller

(76) Inventor: Rolando Gomez, North Bergen, NJ (US)

Correspondence Address: BENJAMIN APPELBAUM, PH.D.;ATTORNEY AT LAW, 27 BENNINGTON DRIVE, FLANDERS, NJ, 07836, US

(21) Appl. No.: 12/072,246

(22) Filed: Feb. 25, 2008

Related U.S. Application Data
(60) Provisional application No. 60/962,759, filed on Jul. 31, 2007.

(51) Int. Cl. B62B 9/00; B23P 11/00

(52) U.S. Cl. 296/37.4; 29/428

(57) ABSTRACT

A tray for attachment to a stroller includes a compartment into which a device, such as a portable entertainment device, can be placed and retained, to educate or entertain a child who is in the stroller. The compartment is within the tray, the walls of the tray forming compartment walls. A lip formed by overlap of the compartment walls with the tray top surface retains the device within the compartment. The compartment bottom includes an opening to facilitate insertion, removal and cooling of the device, and can include a cover for the opening. Connecting brackets that extend from the tray member connect the tray to the stroller by means of a pivoting action and a press-fit between the members of the bracket that retain the stroller frame.

### CROSS-REFERENCE TO RELATED APPLICATIONS

This application claims the benefit of U.S. Provisional Application No. 60/962,759, filed 31 Jul. 2007, the contents of which are incorporated by reference herein in their entirety.

### FIELD OF THE INVENTION

The present invention relates to a tray for holding a portable entertainment device and which tray is intended to be attached to the frame of a stroller, to enable the child to watch and/or interact with the device while in the stroller. Other embodiments include additional compartments to hold various items such as toys, snacks, etc.

### BACKGROUND OF THE INVENTION

One of the problems faced by parents when they are with a child who is in a stroller or other type of child carrier, such as a car seat, bicycle trailer, or the like, is how to keep the child occupied and/or amused. For the purposes of the present specification, the term “parent” or “parents” is also intended to include other persons who may be with the child at any given time, such as, but not limited to, a grandparent or other relative, babysitter, day care personnel, or other types of caregivers.

While the child may sometimes be content to watch their surroundings or play with a toy, the child may still want the parent's attention. Depending upon what the parent is doing, this may not always be possible, and the parent attempts to provide some other distraction or activity for the child. As a consequence, many people with children would love to have a way to keep an infant or toddler occupied as that child (or children) is being pushed in their stroller.

Embodiments of the present invention provide a way to occupy a child's attention, by providing an accessory tray for a stroller which includes an entertainment device, such as a digital video disk (“DVD”) or compact disk (“CD”) player, or combination thereof (“DVD/CD” player) to play entertaining and/or instructional programming for the child. Other embodiments of the present invention include the combination of a stroller with a tray including a compartment for an entertainment device, such as a CD/DVD player or the like. By keeping the child entertained, the present invention enables the parent (or other caregiver) to run errands while the child is being entertained in the comfort of their own stroller.

Embodiments of the present invention offer many solutions for parents of all ages. For example only, while the parents shop at a mall, or are perhaps walking in their neighborhood, it keeps the child safe in the stroller while the parent can continue on their way and not worry about their child.

There are some similar ideas portrayed in units. They are cumbersome and appear to lack the style and safety of the present invention.

In comparison the other strollers lack the style of the present invention, which is also designed to be safe and reliable. The installation of the DVD/CD player on other strollers is time consuming, in contrast to the present invention where no assembly is required, and the device installs easily. The entertainment device fits into the tray, and can be removed when the child is done playing with it, or whenever the parent decides to do so, or the entertainment device can remain with the stroller. The device can also remain attached to the tray when the stroller is folded for transport or storage.

The stroller has an injection molded bracket made of ABS plastic, a cup and battery door, a cut and sewn nylon cord lanyard and an OEM DVD/CD player and stroller.

Leal et al. (U.S. Pat. No. 5,624,156 discloses a child safety seat with an entertainment system, in which a control unit is attached to a side of the seat. Wiring contained within the seat enables sound to be transmitted to speakers which are mounted near where the child's head would be positioned.

Pike et al., U.S. Pat. No. 5,855,384 disclose a detachable and rotatable stroller tray accessory. The tray accessory provides a tray portion, a pair of support members connected to the tray portion and a pair of connection portions, each connection portion being attached to a respective support member. The connection portions are configured to rotatably and detachably connect the tray portion to the stroller.

It is thus apparent that there is a need for an accessory tray that can be used in conjunction with a portable electronic entertainment device, and which can be attached to a stroller or other child-carrying device, and serve to hold the child's attention for a period of time.

Embodiments of the present invention include an accessory tray having a compartment into which a portable electronic device can be attached, and serve as an entertainment, educational or amusement device for a child who is in a stroller, or other type of child carrier, such as a car seat, bicycle trailer, or the like. The tray is designed to be attached to the frame of the stroller, where it can then be locked into position until released by the child's parent or other caregiver.

### BRIEF SUMMARY OF THE INVENTION

An object of the present invention is to provide a tray that can be attached to a stroller or other child-carrier for accommodating a portable electronic device that can be used to educated, entertain or amuse a child.

Another object of the present invention to provide a tray that can be securely fastened to the stroller or other child-carrier.

Another object of the present invention is to provide a tray which can accommodate one or more additional items or accessories, such as a toy, keys or a snack for the child.

Still another object of the present invention is to provide a tray into with the portable electronic device can be easily inserted, retained therein, and be easily removed by a parent or other caregiver.

Embodiments of the present invention include an accessory tray designed to be attached to the frame of a stroller, and into which a device, such as a portable entertainment device, can be positioned. One embodiment comprises a tray for attachment to a stroller includes a compartment into which a device, such as a portable entertainment device, can be placed and retained, to educate or entertain a child who is in the stroller. The compartment is within the tray, the walls of the tray forming compartment walls. A lip formed by overlap of the compartment walls with the tray top surface retains the device within the compartment. The compartment bottom includes an opening to facilitate insertion, removal and cooling of the device, and can include a cover for the opening. Connecting brackets that extend from the tray member connect the tray to the stroller by means of a pivoting action and a press-fit between the members of the bracket that retain the stroller frame.

### BRIEF DESCRIPTION OF THE SEVERAL VIEWS OF THE DRAWINGS

The above objects, and other objects of the invention are achieved in the manner described below, and as shown in the accompanying drawings, in which:

FIG. 1 is a perspective view of a stroller including a tray embodiment of the present invention;

FIG. 2 is a top view of a first tray embodiment, including an entertainment device. The connecting brackets have been omitted; they are shown in FIGS. 9-10.

FIG. 3 is a rear perspective view of the embodiment shown in FIG. 3, without the entertainment device and the connecting brackets.

FIG. 4 is a sectional view taken along line 4-4 of FIG. 2.

FIG. 5 is a cross-sectional view taken along line 5-5 of FIG. 2.

FIG. 6 is a cross-sectional view taken along line 6-6 of FIG. 2.

FIG. 7 is a right side view of the connector arm and partial sectional view of the tray, including a sectional view of the electronic device.

FIG. 8 is an exploded view illustrating a cover for the compartment opening.

FIG. 9 is a perspective view of the connector bracket.

FIG. 10 is a side view of the bracket shown in FIG. 9

FIG. 11 shows a perspective view of an alternate embodiment.

FIG. 12 is a bottom view of the embodiment of FIG. 11.

FIG. 13 is a rear view of the embodiment of FIG. 11.

FIG. 14 is a side view of the embodiment of FIG. 11.

FIG. 15 is a schematic view of an alternate embodiment of an electronic device.

### DETAILED DESCRIPTION OF THE INVENTION

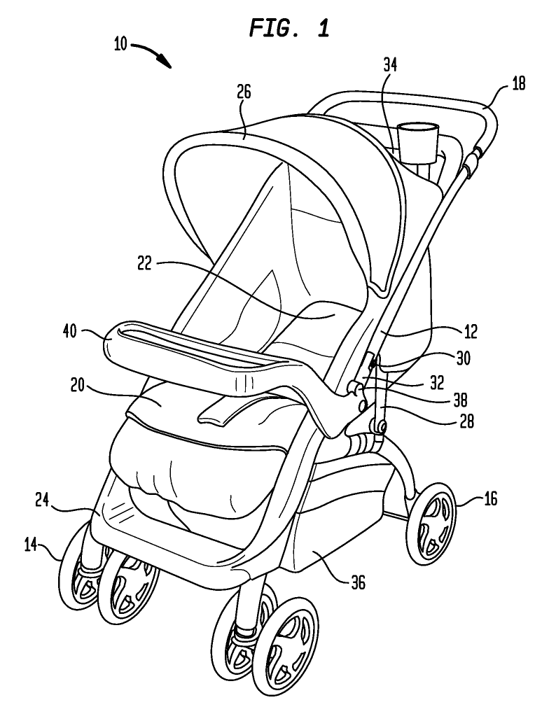

FIG. 1 illustrates a stroller 10 to which one embodiment of the tray 40 of the present invention is attached. The stroller 10 comprises a frame 12, front wheels 14, rear wheels 16, a handle 18, seat 20, seat back 22, footrest 24, canopy 26 and a folding mechanism 28 including release means 30, and a tray 40 attached to the frame 12 at connection points 32. A bag 34 and a shelf 36 may also be attached to the frame, and the canopy 26 may or may not include a window (not shown) therein. The seat back 22 is adjustable, from a horizontal (lying down) position to an intermediate position to an upright position. The handle 18 is reversible, maneuvering on pivot points 38 mounted on the frame 12 at a position above the connection points 32 for the tray 40. As shown in the Figure, each front wheel assembly 14 comprises a pair of wheels mounted on an axle and connected by a connecting means, enabling each front wheel assembly both to rotate and to pivot. Single wheels on either the front or rear could also be utilized.

One embodiment of the present invention is an accessory tray 40 that is designed to be attached to the frame of a stroller. However, it is to be understood that this embodiment could also be attached to other items used for children, such as to a vehicle safety seat, carriage, high chair, booster seat, child carrier, bicycle trailer, motorcycle side car or the like. The accessory tray 40 could also be used on carriages designed to hold two children, where the children are generally sitting one behind the other, by modifications of the connector arms to fasten into such a stroller. Further, one stroller 10 could be coupled to another stroller 10 enabling one person to push two strollers.

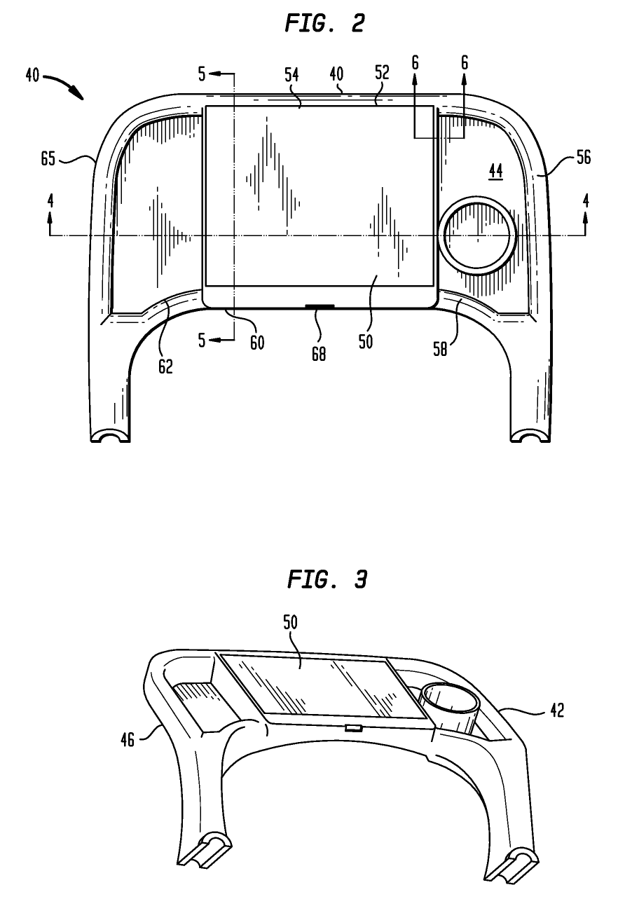

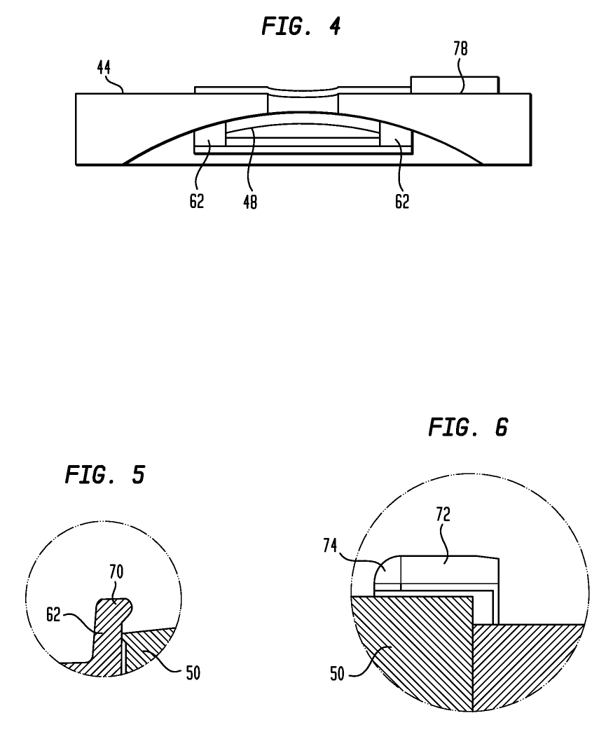

Tray 40 comprises a tray member 42 having a top surface 44 and bottom surface 46. The top surface 44 includes a compartment 48 into which an entertainment device 50 is inserted, and the entertainment device 50 is retained by means of a press-fit within compartment 48 as will be described further below. The entertainment device 50 shown in FIGS. 2-3 is shown in a closed position. Generally, if the entertainment device is one that includes a screen, the top member of the entertainment device will be in an open position, with the screen up and facing the direction of the child. The entertainment device 50 can be a portable device manufactured by corporations such as, for example only and not intended as any limitation, Coby, Matsushita Electronics, Sharp or Sony Corporation. Alternatively, the entertainment device 50 could be supplied by another manufacturer as a private label product, or original equipment manufacturer (“OEM” product). The compartment 48 is designed to accommodate the electronic device 50, whichever manufacturer may supply it. In this embodiment, the electronic device is intended to be battery powered, and that the batteries are contained within the electronic device itself. Embodiments of the present invention are intended to be marketed under the name of “Movie Mobile”.

The tray top surface 44 includes a first wall 52 with a middle region 54 and side regions 56, extending along the front of the tray. A second wall 58 includes a back wall 60 and rear walls 62 that extend along the back of the tray.

The compartment 48 is bounded by a front wall, which corresponds to the middle region 54 of the first wall 52, a back wall 60 which corresponds to the back wall 60 of second wall 58, and a pair of side walls 62. The compartment bottom 64 includes an opening 66 therein, the opening 66 serving as an access point for the parent or other person to facilitate insertion and removal of the entertainment device 50 from the compartment 48. Back wall 60 also includes a notch 68 therein, the notch 68 allowing the parent access to the front of the entertainment device, for purposes of opening it up and setting up the viewing screen, or for aid in inserting and removing the entertainment device 50 from the compartment 48. The opening 66 within the compartment bottom 64 allows for air circulation and cooling of the entertainment device 50.

In another embodiment, the opening 66 could be closed with a cover 67, such as a sheet of the same material that the tray 10 is manufactured of, a clear material such as a plastic, metal or other material, although glass would not be a suitable material because of potential harm to the user.

As shown in the sectional views in FIGS. 5 and 6, the side walls 62 extend upwards from the tray surface and terminate with a lip 70 that overlaps a portion of the entertainment device 50 and retains it within the compartment 48 by means of a press-fit or friction.

The front wall 54 and the back wall 60 extend upward from the tray surface, and terminate with a lip 72 and a prong 74, the prong 74 extending inward towards the compartment 48 and overhanging a portion of the entertainment device 50 and retaining it within the compartment 48 by means of a press-fit or friction. As seen in FIG. 7, the compartment bottom 64 is not horizontal with respect to the plane of the tray 40, but slopes downwardly from the back to the front of the tray 40, providing a comfortable viewing angle when the electronic device 50 is in the open position.

Additional compartment regions 76 are contained within tray top surface 44. These compartment regions 76 are bounded by the side wall 62 on one side, the side regions 56 and rear wall 62. The side walls 56 and the rear walls 62 include curved regions. An additional compartment may be present which is designed to be a cup holder 78, and where needed, the additional compartment regions 76 can be further divided into additional compartments (not shown) depending upon the designs of a particular manufacturer.

A connecting bracket 80 is on each side of the tray 40, enabling the tray 40 to be connected to stroller frame 12. Each connecting bracket 80 comprises a connecting member 82 and a frame member 84, the members being joined by an arm 86 that has a first end 88 pivotably attached to the connecting member 82 by means of a fastener 90. The connecting bracket first end 89 has an arcuate surface 92, and the arcuate surface is configured so that the first end 88 can fit around a portion, generally approximately one-half, of the stroller frame. A groove 96 is at the edge 94 of arcuate surface 92, which will interlock with frame member 84.

The frame member 84 includes a body 98 that has an arcuate surface 100, which is configured so that the frame member 84 can fit around a portion, generally approximately one-half, of the stroller frame. By pivoting either the connecting member 82 or the frame member 84 around the stroller frame 12, the two members will engage each other and become locked by means of a press-fit. The fastener 90, which in the embodiment shown is a screw, can be adjusted so that arm 86 pivots in a manner acceptable to the end user of the tray 40.

The second end 102 of arm 86 terminates in a channel 104. Frame member includes bosses 106 which include an opening 108 therein. A fastener 90, such as a pivot pin, is inserted into channel 104, and is received within bosses 106, pivotably joining the arm 86 to the frame member 84. A tongue 110 on the second end 102 mates with the groove 96 of the connector member 82 to lock the tray 10 in place on the stroller frame 12.

Although the embodiment shown in the drawings utilizes a screw as one fastener 90, other types of fasteners can be utilized, such as a pivot pin, a cotter pin, a bolt, a nail, wire, a dowel, or the like.

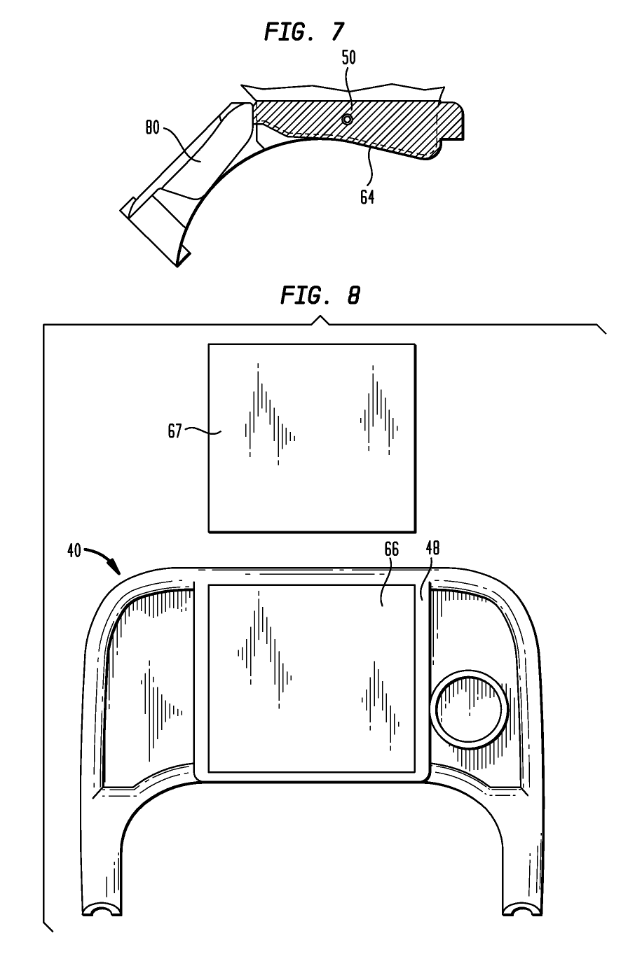

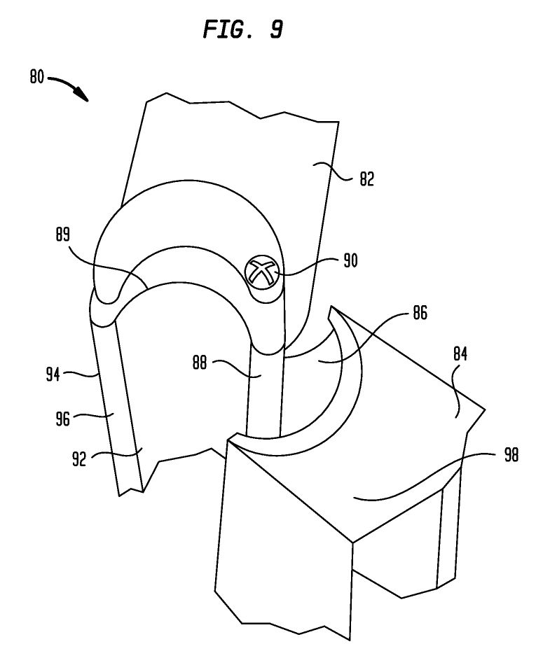

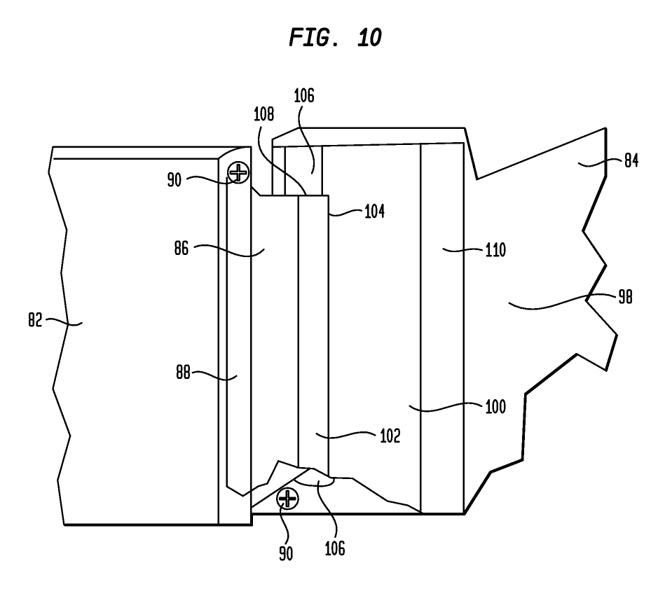

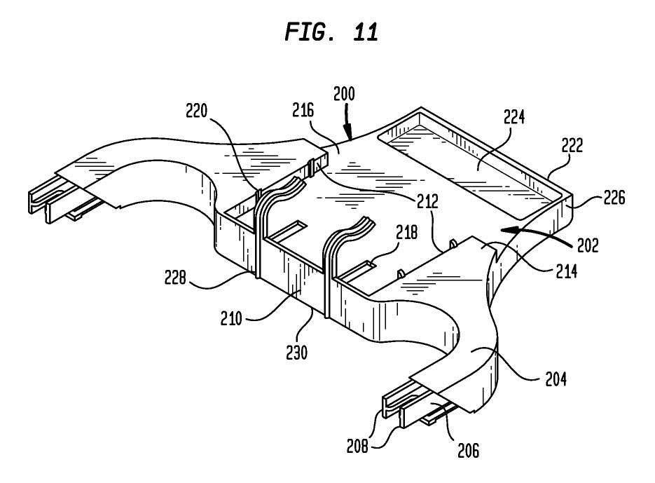

An alternate tray embodiment 200 comprises a body 202 adjoining a pair of connecting arms 204, each of which terminates in a connector 206 (FIGS. 8-11). Each connector 206 includes a pair of grooved connecting prongs 208 designed to engage a pin (not shown) contained within the arm of a stroller. A locking mechanism 240 is positioned beneath the connectors 206 and prongs 208 to secure the tray 200 to the stroller after being inserted therein.

To insert tray 200 into the stroller used for this alternate embodiment, one of the connector prongs 208 is inserted within a first arm of the stroller, making sure a first prong 208 engages the pin in the arm, and then flexing the arms 204 of the tray towards each other so that the second connecting prong 208 will engage and be retained within the second arm of the stroller.

The tray body 202 further comprises a rear wall 210, side walls 212 which are inside most edges of the connector arms 104, which terminate in a forward wall 214. The body top surface 216 further comprises one or more slots 218 proximate the rear wall 210, and which extend forward from the rear wall 210, and one or more ribs 220 adjacent the side walls 212 which project upwards from the top surface 216.

The front most region 222 of the tray body 202 includes a compartment 224 bounded by walls 226. The compartment 224 can be used to hold a battery pack 252 for the device 250, or could hold toys, keys, or other accessories needed by a child, parent, caregiver of the like.

One or more brackets 228 are attached to the rear wall 210, and serve to retain the device 250 within the tray. The height of the brackets 228 can be adjusted to accommodate different sized electronic devices, and are movable to allow for the opening and closing of the device 250 so the child can view its' screen 254. The battery pack 252 is connected to the electronic device 250 by a wire 256 which plugs into a receptacle (not shown) on the device. The brackets extend to the body bottom 230 where they are held in place by means of a fastener 232 such as a screw or bolt. Alternatively, a slot could be made in the body bottom 230, and the brackets inserted therein, and fastened by means of an adhesive, fastener, press fit or the like.

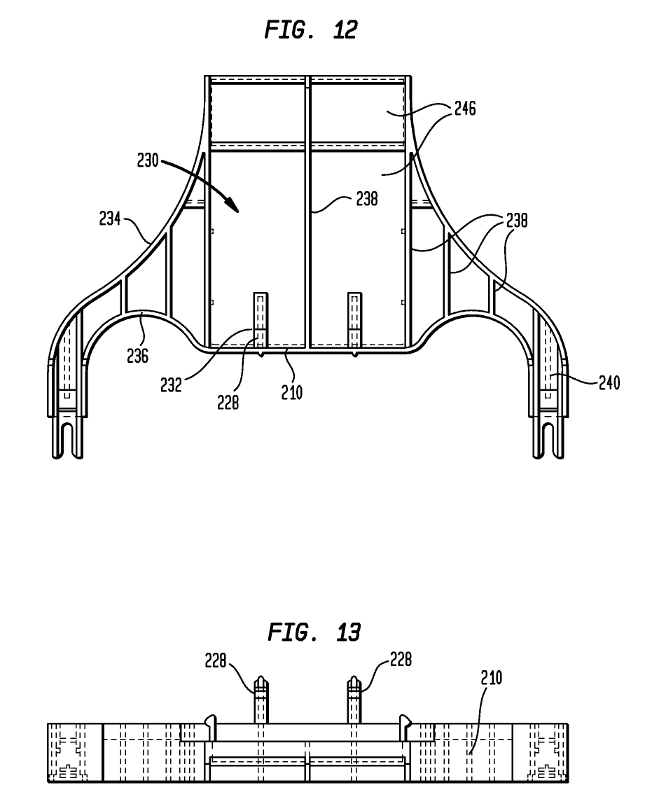

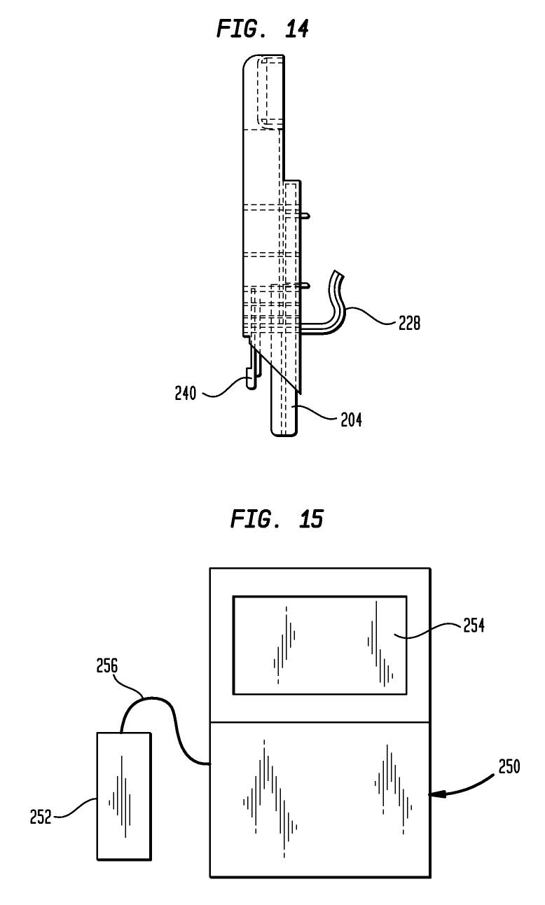

As shown in the bottom view of this embodiment (FIG. 12), the bottom 230 of the tray 200 is generally hollow and surrounded by walls 234 and 236 among which a plurality of ribs 238 are positioned to add structural support and rigidity to the tray 200. The hollow regions 240 underneath the connecting arms 204 also provide areas where the user can place their fingers which handling the tray 200 for purposes such as inserting it or removing it from the stroller, or adjusting the tray's position.

This alternate embodiment 200 can be manufactured from a variety of materials, such as metal or plastic. Although the embodiment shown in the drawings is manufactured from a plastic, such as ABS plastic, and formed using an injection molding process, other types of plastic and other processes known to those skilled in the industry can be used to form this tray. Aluminum is only one example of a metal, but stainless steel or other metals could also be utilized.

The entertainment system as described by embodiments of the present invention can be used as a method for entertaining or educating a child who is positioned in a child carrier or stroller. Generally, the method comprises the steps of attaching the tray, as described in one of the embodiments disclosed herein, to the child carrier. This can be done whether or not the child is already in the child carrier. After the tray has been attached, and secured to the child carrier, the user then inserts the device into the appropriate compartment of the tray, secures the device in the compartment, then opens the device so that the device's screen, speaker or the like, faces in the direction of the child, and then turns on the device to play a specified program. After use, the device is turned off and closed. The device can remain within the tray as needed, and, when necessary, could be retained in the tray even when the child carrier, such as a stroller, is folded.

Therefore, although this invention has been described with a certain degree of particularity, it is to be understood that the present disclosure has been made only by way of illustration and that numerous changes in the details of construction and arrangement of parts may be resorted to without departing from the spirit and scope of the invention.

I claim:

1. A tray for attachment to a stroller having a frame, the tray comprising:
a tray member having a top surface and a bottom surface, the tray member including
a first wall having a middle region and a side region, the first wall extending along the front of the tray;
a second wall having a back region and rear region, the second wall extending along the back of the tray;
a compartment in the tray member, the compartment having a pair of side walls, a front wall that is the first wall middle region, a back wall that is the second wall back wall, the back wall having a notch therein, and a bottom, the compartment bottom having an opening therein, the compartment being sized to receive and retain a device therein;
the compartment further having a means for retaining the device, the means for retaining being a lip, the lip comprising the compartment side and the tray member top surface, the top surface extending over the compartment side; and
a pair of connecting brackets, the brackets extending from the tray member, the brackets comprising a body having an arcuate end and a locking means, the locking means being pivotably attached proximate the arcuate end, the arcuate end shaped so as to receive a portion of the stroller frame therein.

2. The tray as described in claim 1, wherein the device comprises a device chosen from the group consisting of an audio device, a video device, or an audio-video device.

3. The tray as described in claim 2, wherein the locking means further comprises a frame member and a connector arm, the frame member further comprising a body having an arcuate end, the arcuate end shaped so as to receive a portion of the stroller frame therein, the arcuate ends being complementary to one another so that when they are joined, there is a press-fit between them, thereby locking the tray to the stroller.

4. The tray as described in claim 3, wherein the connector arms comprise two members, a first member that attaches to the stroller, and a second member attached to the tray, the connector members being pivotably joined to each other.

5. The tray as described in claim 4, wherein the connector members engage the stroller frame by means of a press-fit.

6. The tray as described in claim 5, wherein the locking means is attached my a fastener chosen from the group consisting of a screw, a pivot pin, a bolt, a rivet, a dowel or a cotter pin.

7. The tray as described in claim 2, further comprising a covering for the opening.

8. The tray as described in claim 2, wherein the device further comprises an external power source connected to the device by a power cord, the power cord extending through the compartment opening to the power source.

9. The tray as described in claim 6, wherein the tray top surface further comprises a second compartment.

10. The tray as described in claim 9, wherein the second compartment is a cup holder.

11. A tray for attachment to a stroller having a frame, the tray comprising:
a tray member having a top surface and a bottom surface, the tray member including
a first wall having a middle region and a side region, the first wall extending along the front of the tray;
a second wall having a back region and rear region, the second wall extending along the back of the tray;
a compartment in the tray member, the compartment having a pair of side walls, a front wall that is the first wall middle region, a back wall that is the second wall back wall, the back wall having a notch therein, and a bottom, the compartment bottom having an opening therein, the compartment being sized to receive and retain a device therein, the device being chosen from the group consisting of an audio device, a video device, or an audio-video device;
the compartment further having a means for retaining the device, the means for retaining being a lip, the lip comprising the compartment side and the tray member top surface, the top surface extending over the compartment side; and
a pair of connecting brackets, the brackets extending from the tray member, the brackets comprising a body having an arcuate end and a locking means,
the arcuate end shaped so as to receive a portion of the stroller frame therein; the locking means being pivotably attached proximate the body arcuate end,
the locking means further comprising a frame member, a stroller member, and a connector arm connecting the frame member and the stroller member, the frame member further comprising a body having an arcuate end, the frame member arcuate end shaped so as to receive a portion of the stroller frame therein, the arcuate ends being complementary to one another so that when they are joined, there is a press-fit between them, thereby locking the tray to the stroller.

12. The tray as described in claim 11, further comprising a covering for the opening.

13. A method for entertaining a child positioned in a child carrier, the method comprising the steps of:
attaching a tray to the child carrier, the tray comprising;
a tray member having a top surface and a bottom surface, the tray member including
a first wall having a middle region and a side region, the first wall extending along the front of the tray;
a second wall having a back region and rear region, the second wall extending along the back of the tray;
a compartment in the tray member, the compartment having a pair of side walls, a front wall that is the first wall middle region, a back wall that is the second wall back wall, the back wall having a notch therein, and a bottom, the compartment bottom having an opening therein, the compartment being sized to receive and retain a device therein, the device being chosen from the group consisting of an audio device, a video device, or an audio-video device;
the compartment further having a means for retaining the device, the means for retaining being a lip, the lip comprising the compartment side and the tray member top surface, the top surface extending over the compartment side; and
a pair of connecting brackets, the brackets extending from the tray member, the brackets comprising a body having an arcuate end and a locking means,
the arcuate end shaped so as to receive a portion of the stroller frame therein; the locking means being pivotably attached proximate the body arcuate end,
the locking means further comprising a frame member, a stroller member, and a connector arm connecting the frame member and the stroller member, the frame member further comprising a body having an arcuate end, the frame member arcuate end shaped so as to receive a portion of the stroller frame therein, the arcuate ends being complementary to one another so that when they are joined, there is a press-fit between them, thereby locking the tray to the stroller;
inserting the device into the compartment;
securing the device in the compartment;
opening the device to face the child; and
turning on the device.

14. The method as described in claim 13, wherein the child carrier is chosen from the group consisting of a stroller, a carriage, a car seat, a bicycle trailer, a high chair, a booster seat or a side car.

15. The tray as described in claim 13, wherein the device further comprises an external power source connected to the device by a power cord, the power cord extending through the compartment opening to the power source.

16. The tray as described in claim 13, wherein the tray top surface further comprises a second compartment.

17. An accessory tray for attachment to a stroller having a frame, the tray comprising:
a body having a front member, a back wall and a top surface, the back wall being higher than the top surface, the body being attached to a pair of connecting arms;
the connecting arms being arcuate and having two ends, a first end attached to the body and being higher than the top surface, the first end forming the tray side, and a second end, the second end terminating in a connecting prong;
a retaining means extending from the tray side;
one or more brackets attached to the rear wall, the brackets having a height that is adjustable, the brackets and the retaining means retaining an entertainment device within the tray;
the front further having a compartment therein;
the connecting arms further comprising a locking mechanism, the locking mechanism being proximate the connecting prong

18. The tray as described in claim 17, wherein the device further comprises an external power source connected to the device by a power cord, the power cord extending through the compartment opening to the power source.
